(19) United States
(12) Patent Application Publication
(10) Pub. No.: US 2021/0301694 A1
(43) Pub. Date: Sep. 30, 2021

(54) EXHAUST LINE FOR A VEHICLE AND VEHICLE WITH AN EXHAUST LINE

(71) Applicant: Faurecia Emissions Control Technologies, Germany GmbH, Augsburg (DE)

(72) Inventor: Catalin FAINA, Augsburg (DE)

(21) Appl. No.: 17/210,785

(22) Filed: Mar. 24, 2021

(30) Foreign Application Priority Data
Mar. 26, 2020 (DE) 10 2020 108 440.4

(51) Int. Cl. F01N 1/02

(52) U.S. Cl. CPC F01N 1/026

(57) ABSTRACT

An exhaust line for a vehicle includes a muffler extending in an axial direction and having a circumferential wall, and a particulate filter arranged upstream of the muffler. The muffler has a chamber having a lateral inlet in the circumferential wall and at least one pipe having a microperforated portion extending in the axial direction and having a sound damping effect. The microperforated portion is arranged in the chamber, and the pipe extends out of the chamber. The muffler is configured such that exhaust gas flows via the lateral inlet radially through the microperforated portion into the pipe and via the pipe out of the muffler. Furthermore, a vehicle having such an exhaust line is provided.

### CROSS-REFERENCE TO RELATED APPLICATIONS

This application is a U.S. non-provisional application claiming the benefit of German Application No. 10 2020 108 440.4, filed on Mar. 26, 2020, which is incorporated herein by reference in its entirety.

### FIELD OF THE INVENTION

The disclosure relates to an exhaust line for a vehicle, comprising a muffler. The disclosure further relates to a vehicle having such an exhaust line.

### BACKGROUND

Exhaust lines for vehicles are known.

It is further known to insert mufflers in the exhaust gas flow of an exhaust line, which reduce the sound emission to the environment of the vehicle. Such mufflers have sound absorbing fiber mats or metal sheets arranged in an outer, gastight housing to dampen the sound emission by absorption or targeted reflection. It is also known to employ pipes or metal sheets having microperforations for sound damping in the interior of such a muffler.

### SUMMARY

A simply structured, yet effective sound damping for an exhaust line of a vehicle is provided. In one example, an exhaust line for a vehicle is provided, including a muffler extending in an axial direction and having a circumferential wall, and a particulate filter arranged upstream of the muffler. The muffler has a chamber having a lateral inlet in the circumferential wall and at least one pipe having a microperforated portion extending in the axial direction and having a sound damping effect. The microperforated portion is arranged in the chamber, and the pipe extends out of the chamber. Furthermore, the muffler is configured such that exhaust gas flows via the lateral inlet radially, i.e. transversely to the axial direction, through the microperforated portion into the pipe and via the pipe out of the muffler.

As used in the disclosure, the term “microperforated portion with sound damping effect” is understood to mean an area having a multitude of adjacently arranged microperforations extending through the pipe wall of the pipe.

Microperforations are openings having a cross-sectional area of a maximum of 2 mm², in particular a maximum of 0.5 mm².

In the region of the microperforated portion, turbulent flows in the exhaust gas flow are damped by converting the energy of the acoustic wave into heat through dynamic viscosity of the boundary layer within the microperforations (dissipation effect). This reduces the proportion of high frequencies in the frequency spectrum, in particular in the range of from 1 kHz to 8 kHz.

It has been found that a particularly effective sound damping can be provided by causing the exhaust gas to flow laterally into the chamber and against the microperforated portion, so that the exhaust gas flows radially through the microperforated portion into the pipe. The particulate filter here ensures that the microperforations of the microperforated portion do not become clogged by particles, in particular soot particles, which are contained in the exhaust gas. This allows an effective sound damping to be ensured on a permanent basis.

The microperforations may account for about 1%-10% in particular 2.3%-6.3%, of the total area of the microperforated portion (degree of perforation). The total area of the microperforated portion here is understood to mean each immediate region in which microperforations are arranged.

The pore size of the individual microperforations is preferably approximately between 0.02 and 2.0 mm², particularly preferably between 0.05 and 0.15 mm².

The individual microperforations may each be circular, oval or slot-shaped. When slots are used, the slot width may be, for example, between 0.01 and 0.15 mm, in particular between 0.01 and 0.1 mm, while the slot length may be approximately 0.5 to 2.5 mm.

In one example, the circumferential wall is an outer wall of the muffler, so that exhaust gas is directed into the muffler directly from outside the muffler via the lateral inlet. This allows the muffler to be designed to be particularly compact and use only a small amount of material.

The proportion of the mass flow of the exhaust gas that flows radially through the microperforated portion and into the pipe may be between 25% and 65%, preferably between 50% and 60%. In this respect, a high proportion has an advantageous effect on the sound damping properties of the muffler. At the same time, the particulate filter ensures that the microperforations are not clogged by soot particles despite the high mass flow that passes through the microperforations.

In a further example, the muffler has a second pipe having a microperforated portion extending in the axial direction and having a sound damping effect, the microperforated portion being arranged in the chamber. Here, the muffler is configured such that exhaust gas flows via the lateral inlet radially through the microperforated portion of the second pipe and into the second pipe and via the second pipe out of the muffler. Thus, the muffler has two pipes through which exhaust gas is conducted out of the muffler in parallel. In this way, the overall conduction cross-section can be increased and thus the backpressure caused by the muffler can be reduced. The microperforated portions of the first and second pipes here ensure effective sound damping, irrespective of which proportion of the exhaust gas flows out of the muffler via which pipe.

In this context, the proportion of the mass flow of the exhaust gas that flows radially through the microperforated portion of the second pipe and into the second pipe can be at least 25%, in particular at least 33%, in order to ensure effective sound damping.

Furthermore, the sum of the proportion of the mass flow of the exhaust gas that flows radially through the microperforated portion of the first pipe and into the first pipe and the proportion of the mass flow of the exhaust gas that flows radially through the microperforated portion of the second pipe and into the second pipe may be at least 75% of the mass flow of the exhaust gas. This means that the major part of the exhaust gas is conducted radially through the microperforated portions of the two pipes. This allows a particularly good sound damping to be achieved.

It may be provided that the microperforated portion of the first pipe and the microperforated portion of the second pipe are arranged on an axis of the inlet, so that the exhaust gas flows through the inlet toward the microperforated portions of the first and second pipes. This has the advantage that the muffler can have a particularly compact design. Accordingly, the two pipes extend side by side in the region of the microperforations.

According to one example, the first pipe extends axially through a first end wall and the second pipe extends axially through a second end wall opposite to the first end wall. This divides the exhaust gas flow and conveys it on in opposite directions, as a result of which the installation space requirement of the exhaust line can be split up between two opposite areas downstream of the muffler.

According to a further example, the lateral inlet is configured such that exhaust gas flows into the chamber perpendicularly to the axial direction. In this way, the flow profile of the exhaust gas through the muffler can be formed such that the sound damping effect of the microperforations in the first pipe and/or the second pipe is particularly effective.

Furthermore, the microperforated portion of the at least one pipe may extend axially into the region in which the inlet is arranged, so that the exhaust gas flows directly against the microperforated portion of the pipe. This has the advantage that a high proportion of the mass flow can flow radially into the pipe via the microperforated portion with little flow resistance. Moreover, this design allows the muffler to have a particularly compact structure.

In a further example, the first pipe and/or the second pipe each terminate in an axial end in the chamber. Here, the axial end has a distance in the axial direction from an end wall or an intermediate wall of the muffler, the distance corresponding to 1.0 to 2.5 diameters, in particular 1.0 diameter, of the respective pipe. This distance ensures a particularly favorable mass flow ratio of exhaust gas that flows radially through the microperforated portion and of exhaust gas that flows longitudinally into the respective pipe via the axial end.

Provision may be made that the first pipe and/or the second pipe each form a tail pipe of the exhaust line, whereby the sound damping microperforated portion(s) is/are integrated directly in the tail pipe(s). In this way, the exhaust line may be designed to be particularly material-saving, so that it can be manufactured cost-efficiently and so as to have a low mass.

According to the disclosure a vehicle having an exhaust line as explained above is also provided.

Further advantages and features will be apparent from the description below and from the accompanying drawings, in which:

### BRIEF DESCRIPTION OF THE DRAWINGS

FIG. 1 shows a schematic illustration of a vehicle according to the disclosure having an exhaust line according to the disclosure;

FIG. 2 shows a schematic illustration of a muffler of the exhaust line from FIG. 1 according to a first embodiment;

FIG. 3 shows a schematic illustration of a muffler of the exhaust line from FIG. 1 according to a second embodiment; and

FIG. 4 shows a schematic illustration of a muffler of the exhaust line from FIG. 1 according to a third embodiment.

### DETAILED DESCRIPTION

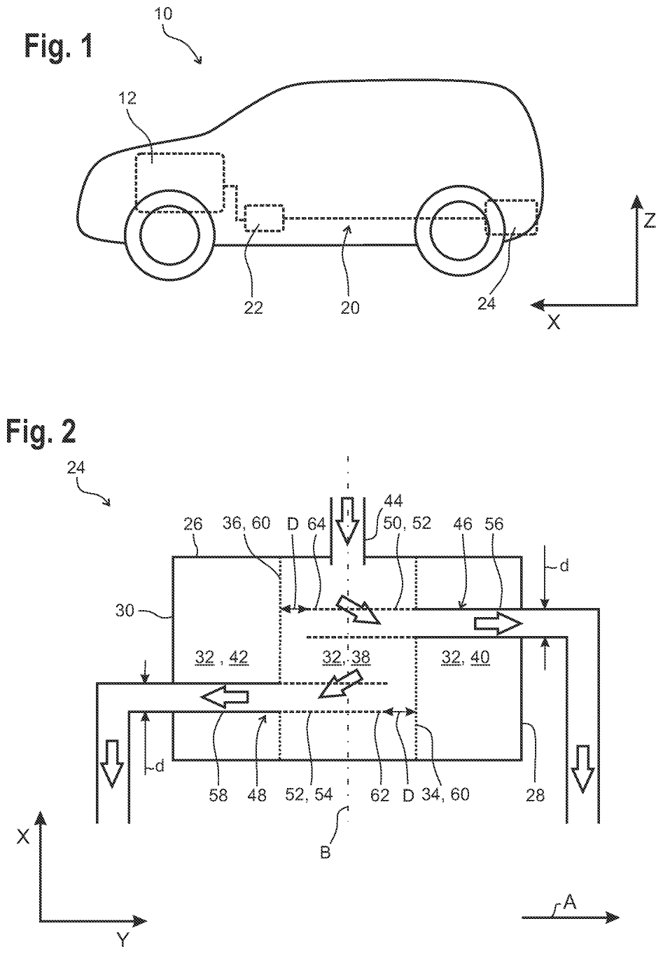

FIG. 1 shows a vehicle 10 having an internal combustion engine 12 and an exhaust line 20 that includes a particulate filter 22 and a muffler 24, in particular a rear muffler, downstream of the particulate filter 22.

The exhaust line 20 here is adapted to conduct the exhaust gases generated during operation of the vehicle 10 from the internal combustion engine 12 out of the vehicle 10 through the particulate filter 22 and subsequently the muffler 24.

The level of detail used in illustrating the exhaust line 20 in FIG. 1 and in describing it below is reduced to the essentials. This means that the exhaust line 20 may comprise further devices such as a catalytic converter, even though they are not explicitly mentioned.

In the present exemplary embodiment, the vehicle 10 is a passenger car.

In an alternative embodiment, the vehicle 10 may be any vehicle, for example a truck, a bus, a rail-bound vehicle or a watercraft.

The internal combustion engine 12 is an Otto engine, for example, and the particulate filter 22 is a gasoline particulate filter.

Alternatively, the internal combustion engine 12 may be a diesel engine and the particulate filter 22 may be a diesel particulate filter.

Basically, the exhaust line 20 may be provided in a vehicle 10 having any desired internal combustion engine 12.

In any case, the exhaust gas is first filtered in the particulate filter 22 to retain soot particulates before it is discharged to the environment via the muffler 24.

The structure of the muffler 24 will be discussed below with reference to FIG. 2, in which the relevant flow profiles of the exhaust gas are illustrated in the form of arrows.

The muffler 24 has a circumferential wall 26, a first end wall 28 and a second end wall 30 arranged opposite to the first end wall 28, which together define a chamber 32 of the muffler 24.

Furthermore, the circumferential wall 26, the first end wall 28, and the second end wall 30 each form an outer wall of the muffler 24.

Alternatively, the circumferential wall 26, the first end wall 28 and/or the second end wall 30 may be provided inside the muffler 24, that is, the respective wall 26, 28, 30 is arranged between the chamber 32 and a corresponding outer wall of the muffler 24.

The circumferential wall 26 extends in the axial direction A, which in the present exemplary embodiment is perpendicular to the direction of extent X of the vehicle 10, which also corresponds to the primary direction of travel of the vehicle 10.

In an alternative embodiment, the axial direction A, in which the circumferential wall 26 extends, may of course be arranged as desired, in particular transversely to the direction of extent X of the vehicle 10.

The chamber 32 is divided into a primary chamber 38 as well as a first secondary chamber 40 and a second secondary chamber 42 by intermediate walls 34, 36 of the muffler 24.

The first intermediate wall 34 separates the primary chamber 38 from the first secondary chamber 40, while the second intermediate wall 36 separates the primary chamber 38 from the second secondary chamber 42.

The intermediate walls 34 may be microperforated.

Furthermore, the muffler 24 has an inlet 44, through which the exhaust gas flows into the chamber 32, and a first pipe 46 and a second pipe 48, through which the exhaust gas is directed out of the chamber 32.

The inlet 44 is provided at the circumferential wall 26 and thus laterally on the muffler 24 and opens directly into the primary chamber 38.

Furthermore, the inlet 44 extends away from the primary chamber 38 perpendicularly to the axial direction A so that, in a side view, the exhaust gas flows into the primary chamber 38 via the inlet 44 perpendicularly to the axial direction A.

The pipes 46, 48 each have a circular cross section with a constant diameter d, within the muffler 24.

The first pipe 46 extends from an axial end 64 in the axial direction A away from the second intermediate wall 36 and out of the chamber 32 through the primary chamber 38, the first intermediate wall 34, the first secondary chamber 40 and the first end wall 28.

A gap having a width D is formed between the axial end 64 of the first pipe 46 and the second intermediate wall 36 and defines the distance of the first pipe 46 from the second intermediate wall 36.

The width D here corresponds to the diameter d of the first pipe 46 within the muffler 24.

The second pipe 48 extends from an axial end 62 counter to the axial direction A away from the first intermediate wall 34 and out of the chamber 32 through the primary chamber 38, the second intermediate wall 36, the second secondary chamber 42 and the second end wall 30.

A gap having a width D is also formed between the axial end 62 of the second pipe 48 and the first intermediate wall 34 and defines the distance of the second pipe 48 from the first intermediate wall 34.

The width D here corresponds to the diameter d of the second pipe 48, which in this embodiment is identical to the diameter d of the first pipe 46.

Of course, in an alternative embodiment, the gaps may have different sizes.

Further, in an alternative embodiment, the width D each may be between 1.0 and 2.5 diameters d of the first pipe 46 and the second pipe 48, respectively.

The first and second pipes 46, 48 are open on the face side.

In an alternative embodiment, the first pipe 46 extends as far as the second intermediate wall 36 and/or the second pipe 48 extends as far as the first intermediate wall 34, so that no gap that separates the pipe 46, 48 and the intermediate wall 34, 36 from each other is formed between the pipe 46, 48 and the respective intermediate wall 34, 36 (see FIG. 4).

In this case, the muffler 24 is configured to allow for thermal expansion of the components during operation of the muffler 24, so that no stresses occur that impair or damage the muffler 24.

This can be ensured in particular in that each of the pipes 46, 48 is fastened to at most one of the intermediate walls 34, 36, rather than to both at the same time.

The pipes 46, 48 may each be open on the face side here and may open into the respective secondary chamber 32, 40 by the opening.

The two pipes 46, 48 are tail pipes of the exhaust line 20 which, outside the chamber 32, extend counter to the direction of extent X, so that the exhaust gas flows out of them counter to the primary direction of travel X of the vehicle 10.

Basically, the pipes 46, 48 may be any desired pipes, in particular tail pipes of any desired configuration.

Furthermore, in an alternative embodiment, it may be provided that both pipes 46, 48 extend in the axial direction A through the first end wall 28 out of the chamber 32.

The portion 50 of the first pipe 46 arranged within the primary chamber 38 includes a microperforated portion 52 having sound damping microperforations via which exhaust gas flows through the pipe wall into the interior of the first pipe 46 transversely to the axial direction A.

The microperforated portion 52 extends over the entire portion 50. This means that the pipe wall of the portion 50 is entirely provided with microperforations in the axial direction A and in the circumferential direction of the pipe 46.

In an alternative embodiment, the microperforated portion 52 may extend only over part of the circumference of the pipe 46 and/or only over an axial part of the portion 50.

Further, the portion 50 may include a plurality of microperforated portions 52, each having any desired size and shape.

In other words, one or more regions of the portion 50 may be adapted to be gastight.

The portion 54 of the second pipe 48, which is arranged in the primary chamber 38, includes a microperforated portion 52 with sound damping microperforations, by analogy with the first pipe 46.

The portion 50 of the first pipe 46 and the portion 54 of the second pipe 48 are of identical configuration.

In principle, however, the portions 50, 54 may be individually configured to have one or more microperforated portions 52.

The portion 50 of the first pipe 46 and the portion 54 of the second pipe 48 intersect a common axis B that extends through the inlet 44 out of the muffler 24.

The inlet 44 is designed to be coaxial with the axis B.

Thus, the exhaust gas flowing in via the inlet 44 flows into the chamber 32 along the axis B and therefore along a line on which the microperforated portions 52 of the first and second pipes 46, 48 are arranged.

In an alternative embodiment, the microperforated portions 52 of the first and second pipes 46, 48 may be arranged in relation to the inlet 44 in any desired manner Preferably, however, at least the microperforated portion 52 of the first pipe 46 or that of the second pipe 48 extends in the axial direction A through an area directly opposite the inlet 44 on the axis B. As a result, the microperforated portions 52 of the pipes 46, 48 extend side by side.

The intermediate walls 34, 36 each have a perforation 60 that extends over the entire surface of the intermediate walls 34, 36.

The perforations 60 each have circular openings with a pore size of from 0.5 to 3 mm² and a degree of perforation of from 2 to 7%, in particular 5%.

Basically, the perforations 60 may each be of any desired configuration, in particular in the form of microperforated portions.

Additionally or alternatively, the perforations 60 may each extend over any desired area of the intermediate walls 34, 36.

Thus, the first secondary chamber 40 is in fluid communication with the primary chamber 38 via the perforation 60 of the first intermediate wall 34 and is in fluid communication with the interior of the second pipe 48 via the axial end 62 of the second pipe 48 arranged in the chamber 32.

Further, the second secondary chamber 42 is in fluid communication with the primary chamber 38 via the perforation 60 of the second intermediate wall 36, and is in fluid communication with the interior of the first pipe 46 via the axial end 64 of the first pipe 46 arranged in the chamber 32.

The primary chamber 38 as well as the secondary chambers 40, 42 are empty, that is, they have no sound damping inserts, such as fiber mats, arranged therein.

In an alternative embodiment, at least one of the chambers 38, 40, 42 may have a sound damping insert introduced therein.

Additionally or alternatively, further elements, such as connecting pipes, metal sheets, and/or shields, may be provided in at least one of the chambers 38, 40, 42.

During operation of the internal combustion engine 12, the exhaust gas flows into the chamber 32 via the inlet 44 and out of the chamber 32 proportionately through the first pipe 46 and the second pipe 48, with a part of the mass flow entering the respective pipe 46, 48 radially through the microperforated portion 52 and a further part entering the respective pipe 46, 48 longitudinally via the axial end 62, 64, and being directed from there out of the vehicle 10.

The proportion of the mass flow that flows radially through the microperforated portion 52 of the first pipe 46 and into the first pipe 46, and the proportion of the mass flow that flows radially through the microperforated portion 52 of the second pipe 48 and into the second pipe 48, each amounts to 30%.

The remaining 40% of the mass flow flows longitudinally through the axial ends 62, 64 into the respective pipe 46, 48 by a proportion of 20% each.

The proportions of the mass flow that flow radially through the microperforated portion 52 and/or longitudinally via the axial end 62, 64, respectively, and into the respective pipe 46, 48 may obviously be of any desired magnitude.

Further, the proportion of the mass flow passing through the first pipe 46 may be greater than the proportion of the mass flow passing through the second pipe, in particular if the first pipe 46 is arranged closer to the inlet 44 than the second pipe 48.

However, to ensure a particularly effective sound damping, the proportion flowing into the pipes 46, 48 radially through the microperforated portions 52 is preferably at least 25% each, in particular at least 33% each.

In an embodiment with only one single pipe 46, 48, the proportion flowing radially through the microperforated portion 52 and into the pipe 46, 48 may be between 25% and 65%, preferably between 50% and 60%.

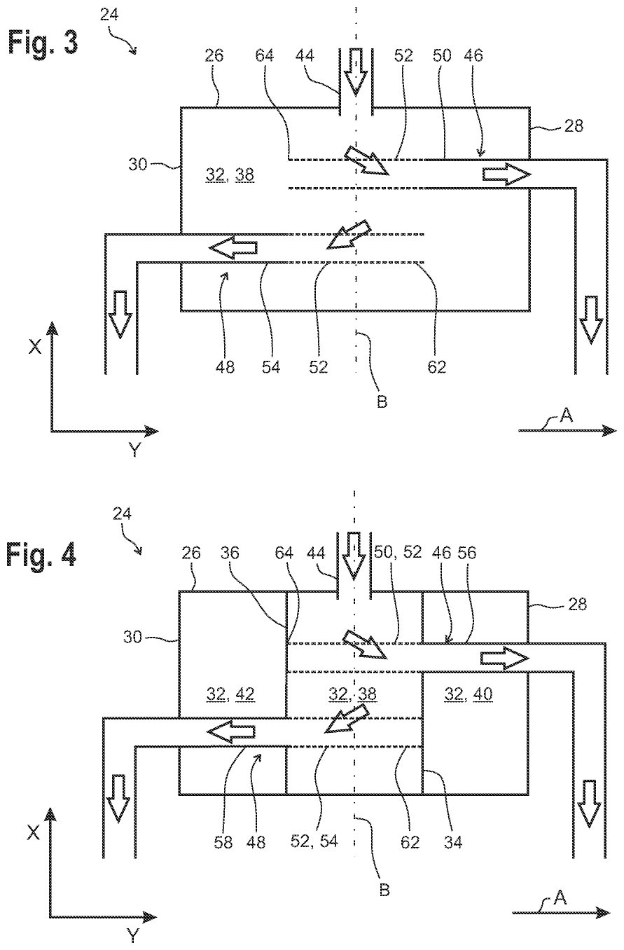

With reference to FIG. 3, an exhaust line 20 according to a second embodiment will now be described. The same reference numbers are used on the components that are known from the above embodiment and, in this regard, reference is made to the preceding discussions.

Unlike in the first embodiment, the muffler 24 does not have intermediate walls 34, 36 that divide the chamber 32.

In other words, the chamber 32 is the primary chamber 38. That is, there are none of the secondary chambers 40, 42 and thus no portions 56, 58 of the pipes 46, 48 extending therethrough.

The microperforated portion 52 of the first pipe 46 extends from the axial end 64 over 50% of the portion 50 in the axial direction A, while the microperforated portion 52 of the second pipe 48 extends from the axial end 62 over 50% of the portion 54 counter to the axial direction A.

The exhaust gas flowing into the chamber 32 via the inlet 44 during operation of the internal combustion engine 12 flows proportionately through the microperforated portions 52 and the axial ends 62, 64 and out of the chamber 32 via the pipes 46, 48.

The proportion of the mass flow that flows radially through the microperforated portion 52 of the first pipe 46 and into the first pipe 46 and the proportion of the mass flow that flows radially through the microperforated portion 52 of the second pipe 48 and into the second pipe 48 are each 33%.

The remaining proportion of the mass flow flows in equal shares longitudinally into the pipes 46, 48 via the respective axial ends 62, 64.

With reference to FIG. 4, an exhaust line 20 according to a third embodiment will now be described. The same reference numbers are used on the components that are known from the above embodiments and, in this regard, reference is made to the preceding discussions.

Unlike in the first embodiment, the intermediate walls 34, 36 are made to be gastight.

This means that the intermediate walls 34, 36 do not have perforations 60 by which the secondary chambers 40, 42 are in direct fluid communication with the primary chamber 38.

Furthermore, in this embodiment, the pipes 46, 48 have their axial ends 62, 64 adjacent to the intermediate walls 34, 36 so that there are no gaps between the latter and the axial ends 62, 64.

To prevent the muffler 24 from being damaged by thermal expansion of the components during operation, the pipes 46, 48 are each attached to at most one of the intermediate walls 34, 36, rather than to both at the same time.

Since the intermediate walls 34, 36 do not have any perforations 60, the axial ends 62, 64 of the pipes 46, 48 are sealed so that no exhaust gas can flow longitudinally into the respective pipe 46, 48 via the axial ends 62, 64.

Since the intermediate walls 34, 36 do not have any perforations 60, the axial ends 62, 64 of the pipes 46, 48 are sealed so that no exhaust gas can flow longitudinally into the respective pipe 46, 48 via the axial ends 62, 64.

This causes all of the exhaust gas in the primary chamber 38 that has entered the chamber 32 via the inlet 44 to flow radially through the microperforated portions 52 into the pipes 46, 48 and out of the chamber 32 via the pipes 46, 48.

In all embodiments, an exhaust line 20 is provided that features particularly low sound emissions by way of the sound damping microperforated portions 52.

At the same time, the particulate filter 22 ensures that the exhaust gas flowing through the muffler 24 is cleaned of particulates. This reliably prevents particulates from clogging the microperforated portions 52, so that the sound damping properties of the muffler 24 remain permanently high.

The disclosure is not limited to the embodiments shown. In particular, individual features of one example may be combined with features of other examples as desired, in particular independently of the other features of the respective examples.

Although various embodiments have been disclosed, a worker of ordinary skill in this art would recognize that certain modifications would come within the scope of this disclosure. For that reason, the following claims should be studied to determine the true scope and content of this disclosure.

1. An exhaust line for a vehicle, comprising:
a muffler extending in an axial direction and having a circumferential wall; and
a particulate filter arranged upstream of the muffler, wherein the muffler includes
a chamber having a lateral inlet in the circumferential wall,
at least one pipe having a microperforated portion extending in the axial direction and having a sound damping effect,
wherein the microperforated portion is arranged in the chamber and the at least one pipe extends out of the chamber, and
wherein the muffler is configured such that exhaust gas flows via the lateral inlet radially through the microperforated portion into the at least one pipe and via the at least one pipe out of the muffler.

2. The exhaust line according to claim 1, wherein the circumferential wall is an outer wall of the muffler.

3. The exhaust line according to claim 1, wherein a proportion of a mass flow of the exhaust gas that flows radially through the microperforated portion into the at least one pipe is between 25% and 65%.

4. The exhaust line according to claim 1, wherein the at least one pipe comprises at least a first pipe, and wherein the muffler has a second pipe having a microperforated portion extending in the axial direction and having a sound damping effect, the microperforated portion of the second pipe being arranged in the chamber, and the muffler being configured such that exhaust gas flows via the lateral inlet radially through the microperforated portion of the second pipe into the second pipe and via the second pipe out of the muffler.

5. The exhaust line according to claim 4, wherein a proportion of a mass flow of the exhaust gas that flows radially through the microperforated portion of the second pipe into the second pipe is at least 25%.

6. The exhaust line according to claim 4, wherein a sum of a proportion of a mass flow of the exhaust gas that flows radially through the microperforated portion of the first pipe and into the first pipe and a proportion of a mass flow of the exhaust gas that flows radially through the microperforated portion of the second pipe and into the second pipe is at least 75% of a mass flow of the exhaust gas.

7. The exhaust line according to claim 4, wherein the microperforated portion of the first pipe and the microperforated portion of the second pipe are arranged on an axis of the lateral inlet.

8. The exhaust line according to claim 4, wherein the first pipe extends axially through a first end wall and the second pipe extends axially through a second end wall opposite to the first end wall.

9. The exhaust line according to claim 1, wherein the lateral inlet is configured such that exhaust gas flows into the chamber perpendicularly to the axial direction.

10. The exhaust line according to claim 1, wherein the microperforated portion of the at least one pipe extends axially into a region in which the lateral inlet is arranged.

11. The exhaust line according to claim 4, wherein the first pipe and/or the second pipe each terminate in an axial end in the chamber, the axial end having a distance in the axial direction from an end wall or an intermediate wall of the muffler, the distance corresponding to 1.0 to 2.5 diameters of a respective one of the first pipe and/or second pipe.

12. The exhaust line according to claim 4, wherein the first pipe and/or the second pipe each form a tail pipe of the exhaust line.

13. A vehicle comprising:
an exhaust line for a vehicle, comprising
a muffler extending in an axial direction and having a circumferential wall, and a particulate filter arranged upstream of the muffler,
wherein the muffler includes a chamber having a lateral inlet in the circumferential wall, and at least one pipe having a microperforated portion extending in the axial direction and having a sound damping effect,
wherein the microperforated portion is arranged in the chamber and the at least one pipe extends out of the chamber, and wherein the muffler is configured such that exhaust gas flows via the lateral inlet radially through the microperforated portion into the at least one pipe and via the at least one pipe out of the muffler.
